(19) United States
(12) Patent Application Publication
(10) Pub. No.: US 2025/0110431 A1
(43) Pub. Date: Apr. 3, 2025

(54) HEATING DEVICE AND HEAT TREATMENT SYSTEM USING THE SAME

(71) Applicant: FUJIFILM Business Innovation Corp., Tokyo (JP)

(72) Inventors: Jouta KOBAYASHI, Kanagawa (JP); Kiyoshi Iwai, Kanagawa (JP); Toru Inoue, Kanagawa (JP); Toshiyuki Miyata, Kanagawa (JP); Mizuki Sugino, Kanagawa (JP); Hiroki Yamazaki, Kanagawa (JP)

(73) Assignee: FUJIFILM Business Innovation Corp., Tokyo (JP)

(21) Appl. No.: 18/587,275

(22) Filed: Feb. 26, 2024

(30) Foreign Application Priority Data
Sep. 28, 2023 (JP) 2023-168656

(51) Int. Cl. G03G 15/20

(52) U.S. Cl. CPC G03G 15/2053; G03G 15/2064

(57) ABSTRACT

A heating device includes a belt-shaped heated unit that rotates in a circulating manner, a heat generation unit that is provided in contact with a back surface side of the heated unit, and extends in an intersection direction intersecting with a rotation direction of the heated unit to heat the heated unit, a pressurization unit that brings the heated unit and the heat generation unit into contact with each other in a pressurized state to form a contact region being in contact with the heated unit and extending in a longitudinal direction of the heat generation unit, and a pressurization adjustment unit that adjusts the pressurized state by the pressurization unit so that a width in a lateral direction of the contact region changes, in which the heat generation unit includes plural heat generation resistors extending in the longitudinal direction, a high heat generation portion being narrow and having a high heat generation amount and a low heat generation portion being wide and having a low heat generation amount are formed in a row in the plural heat generation resistors, and for at least two heat generation resistors among the plural heat generation resistors, the high heat generation portions are formed in different regions in the longitudinal direction of the contact region, and in a case where a minimum contact region having a minimum width in the lateral direction of the contact region is formed by the pressurization unit, for the at least two heat generation resistors, an entire high heat generation portion is included in a range of the minimum contact region, a part of the low heat generation portion is included in the range of the minimum contact region, and a remaining part of the low heat generation portion is outside the range of the minimum contact region.

### CROSS-REFERENCE TO RELATED APPLICATIONS

This application is based on and claims priority under 35 USC 119 from Japanese Patent Application No. 2023-168656 filed Sep. 28, 2023.

### BACKGROUND

### (i) Technical Field

The present invention relates to a heating device and a heat treatment system using the same.

### (ii) Related Art

For example, JP5618771B (DETAILED DESCRIPTION and FIG. 4) discloses a heating device in the related art.

JP5618771B (DETAILED DESCRIPTION and FIG. 4) discloses a fixing device including a cylindrical belt, a heater that has a first heat generation resistor and a second heat generation resistor formed along a longitudinal direction of an elongated substrate and comes into contact with an inner surface of the belt, and a backup roller that forms a nip unit for transporting and heating a recording material on which a toner image is carried, together with the heater via the belt, in which the first heat generation resistor has a resistance value per unit length of an end portion in the longitudinal direction of the substrate lower than a resistance value of a central portion, and the fixing device has a first fixing treatment mode in which the entire first heat generation resistor and second heat generation resistor come into a contact region in which the heater and the belt come into contact with each other, and a second fixing treatment mode in which the entire first heat generation resistor come into the contact region and at least a part of the second heat generation resistor protrudes from the contact region in a transport direction of the recording material.

### SUMMARY

Aspects of non-limiting embodiments of the present disclosure relate to a heating device and a heat treatment system using the same that suppresses, in a case of forming a contact region for heating between a belt-shaped heated unit and a heat generation unit, an excessive temperature rise around the contact region without increasing a pressurization load on the contact region.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a heating device including: a belt-shaped heated unit that rotates in a circulating manner; a heat generation unit that is provided in contact with a back surface side of the heated unit, and extends in an intersection direction intersecting with a rotation direction of the heated unit to heat the heated unit; a pressurization unit that brings the heated unit and the heat generation unit into contact with each other in a pressurized state to form a contact region being in contact with the heated unit and extending in a longitudinal direction of the heat generation unit; and a pressurization adjustment unit that adjusts the pressurized state by the pressurization unit so that a width in a lateral direction of the contact region changes, in which the heat generation unit includes a plurality of heat generation resistors extending in the longitudinal direction, a high heat generation portion being narrow and having a high heat generation amount and a low heat generation portion being wide and having a low heat generation amount are formed in a row in the plurality of heat generation resistors, and for at least two heat generation resistors among the plurality of heat generation resistors, the high heat generation portions are formed in different regions in the longitudinal direction of the contact region, and in a case where a minimum contact region having a minimum width in the lateral direction of the contact region is formed by the pressurization unit, for the at least two heat generation resistors, an entire high heat generation portion is included in a range of the minimum contact region, a part of the low heat generation portion is included in the range of the minimum contact region, and a remaining part of the low heat generation portion is outside the range of the minimum contact region.

### BRIEF DESCRIPTION OF THE DRAWINGS

Exemplary embodiment(s) of the present invention will be described in detail based on the following figures, wherein:

FIG. 1A is an explanatory diagram showing an outline of an exemplary embodiment of a heat treatment system including a heating device to which the present invention is applied, and FIG. 1B is an explanatory diagram showing details of a heat generation unit shown in FIG. 1A;

FIG. 2 is an explanatory diagram showing an overall configuration of an image formation system according to Exemplary Embodiment 1;

FIG. 3 is an explanatory diagram showing a configuration example of a fixing device and a periphery of the fixing device according to Exemplary Embodiment 1;

FIG. 4A is an explanatory diagram showing a configuration example of a heat generation component of the fixing device according to Exemplary Embodiment 1, and FIG. 4B is an explanatory diagram showing a layout of a heat generation resistor of the heat generation component in a width direction of a contact region in a case where a narrow contact region is used;

FIG. 5 is an explanatory diagram showing patterns and heat generation amounts of a plurality of heat generation resistors of the heat generation component in Exemplary Embodiment 1;

FIG. 6 is an explanatory diagram showing an example of a contact region variable mechanism used in Exemplary embodiment 1;

FIG. 7A is an explanatory diagram showing an operating state in a case where a wide normal contact region is set by the contact region variable mechanism, and FIG. 7B is an explanatory diagram showing an operating state in a case where a narrow minimum contact region is set by the contact region variable mechanism;

FIG. 8 is a flowchart showing a heat and pressurization treatment process of the fixing device according to Exemplary Embodiment 1;

FIG. 9A is an explanatory diagram showing a layout of a narrow contact region of a heat generation component of a fixing device according to Comparative Form 1, and FIG. 9B is an explanatory diagram showing a solution to the technical problem shown in FIG. 9A;

FIG. 10 is an explanatory diagram showing a major part of a contact region variable mechanism according to Modification Form 1-1;

FIG. 11 is an explanatory diagram showing a pattern example of a heat generation resistor of a heat generation component in a case where a side reference method in which a side in a width direction intersecting with a movement direction of a medium is used as a reference is adopted in a transport method of the medium;

FIG. 12 is an explanatory diagram showing patterns and heat generation amounts of a plurality of heat generation resistors of a heat generation component of a fixing device according to Exemplary Embodiment 2;

FIG. 13A is an explanatory diagram showing a layout of the heat generation resistor of the heat generation component in a width direction of a contact region in a case where a wide normal contact region is used, and FIG. 13B is an explanatory diagram showing a layout of the heat generation resistor of the heat generation component in the width direction of the contact region in a case where a narrow minimum contact region is used;

FIG. 14 is an explanatory diagram showing a major part of a fixing device according to Exemplary Embodiment 3;

FIG. 15 is an explanatory diagram showing details of a structure around a heat generation component of the fixing device according to Exemplary Embodiment 3; and

FIG. 16A is an explanatory diagram showing a layout of the heat generation component in a case where a narrow minimum contact region is used, and FIG. 16B is an explanatory diagram showing a layout of the heat generation component in a case where a wide normal contact region is used.

### DETAILED DESCRIPTION

### Outline of Exemplary Embodiment

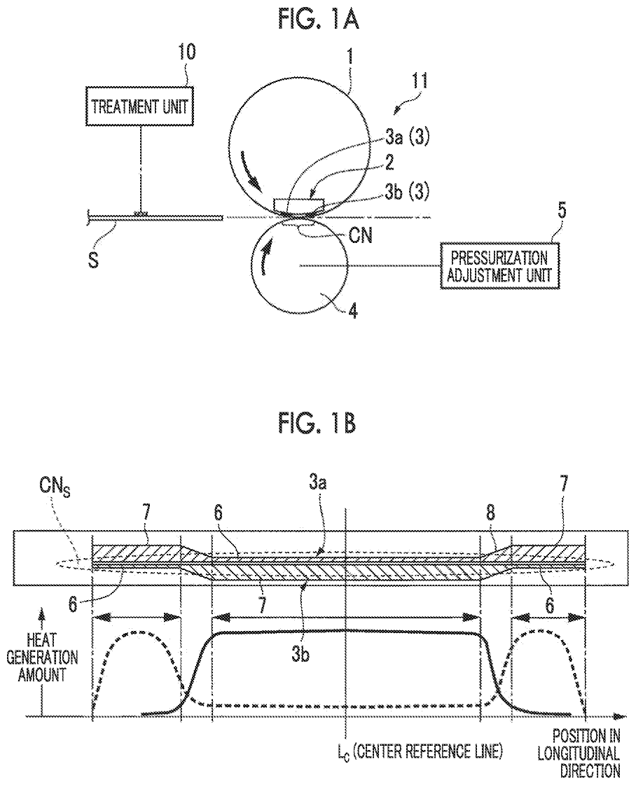

FIG. 1A shows an outline of Exemplary Embodiment 1 of a heat treatment system including a fixing device to which the present invention is applied.

In FIG. 1, the heat treatment system includes a treatment unit 10 that performs a predetermined treatment on a heating target medium S, and a heating device 11 that heats the heating target medium S subjected to the treatment by the treatment unit 10.

As this type of heat treatment system, the treatment unit 10 is an image formation unit that forms an unfixed image on the heating target medium S, and the heating device 11 is a fixing device that fixes the unfixed image formed on the heating target medium S.

In the present example, the heating device 11 includes a belt-shaped heated unit 1 that rotates in a circulating manner, a heat generation unit 2 that is provided in contact with a back surface side of the heated unit 1, and extends in an intersection direction intersecting with a rotation direction of the heated unit 1 to heat the heated unit 1, a pressurization unit 4 that brings the heated unit 1 and the heat generation unit 2 into contact with each other in a pressurized state to form a contact region CN being in contact with the heated unit 1 and extending in a longitudinal direction of the heat generation unit 2, and a pressurization adjustment unit 5 that adjusts the pressurized state by the pressurization unit 4 so that a width in a lateral direction of the contact region CN changes, in which, as shown in FIG. 1B, the heat generation unit 2 includes a plurality of heat generation resistors 3 (3a and 3b) extending in the longitudinal direction, a high heat generation portion 6 being narrow and having a high heat generation amount and a low heat generation portion 7 being wide and having a low heat generation amount are formed in a row in the plurality of heat generation resistors 3, and for at least two heat generation resistors (3a and 3b) among the plurality of heat generation resistors 3, the high heat generation portion 6 is formed in different regions in the longitudinal direction of the contact region CN, and in a case where a minimum contact region CN_{S} having a minimum width in the lateral direction of the contact region CN is formed by the pressurization unit 4, for the at least two heat generation resistors (3a and 3b) among the plurality of heat generation resistors 3, an entire high heat generation portion 6 is included in a range of the minimum contact region CN_{S}, a part of the low heat generation portion 7 is included in the range of the minimum contact region CN_{S}, and a remaining part of the low heat generation portion 7 is outside the range of the minimum contact region CN_{S}.

In the present example, in a case where the heat generation unit 2 includes three or more heat generation resistors 3, the two heat generation resistors (3a and 3b) need to be disposed in the minimum contact region CN_{S} as described above. In this case, in a case where the minimum contact region CN_{S} is used, the two heat generation resistors (3a and 3b) may be used to perform the heat treatment. Therefore, for the heat generation resistors other than the two heat generation resistors (3a and 3b), the patterns (patterns of the high heat generation portion 6 and the low heat generation portion 7) may be appropriately selected in consideration of the size of the heating target medium S and the like.

On the other hand, in an aspect in which the heat generation unit 2 includes the two heat generation resistors 3, specifically, the first heat generation resistor 3a and the second heat generation resistor 3b that extend in the longitudinal direction, the high heat generation portion 6 being narrow and having a high heat generation amount and the low heat generation portion 7 being wide and having a low heat generation amount may be formed in a row in the first heat generation resistor 3a, and the high heat generation portion 6 and the low heat generation portion 7 may be formed in a row in the second heat generation resistor 3b in a region different from the first heat generation resistor 3a, and in a case where the minimum contact region CN_{S} having the minimum width in the lateral direction of the contact region CN is formed by the pressurization unit 4, the entire high heat generation portion 6 of the first heat generation resistor 3a and second heat generation resistor 3b may be included in the range of the minimum contact region CN_{S}, a part of the low heat generation portion 7 may be included in the range of the minimum contact region CN_{S}, and a remaining part of the low heat generation portion 7 may be outside the range of the minimum contact region CN_{S}.

In such a technical unit, the heated unit 1 may be a belt-shaped member that rotates in a circulating manner. As the circulation rotation method of the heated unit 1, for example, one of tension units that stretches the heated unit 1 may be rotationally driven by a drive source, or for example, the heated unit 1 may be rotationally driven by using the pressurization unit 4 as a drive source.

In addition, the heat generation unit 2 may be disposed in contact with a back surface of the heated unit 1, and is not limited to an aspect in which the heat generation unit 2 is disposed to face the pressurization unit 4. Further, typical examples of the heat generation unit 2 include a heat generation unit using a planar heat generator, and the heat generation unit 2 can be applied to a heat generator other than the planar heat generator.

Further, the pressurization unit 4 may be appropriately selected as long as the heated unit 1 and the heat generation unit 2 are brought into contact with each other in a pressurized state.

Furthermore, the pressurization adjustment unit 5 may adjust the pressurized state by the pressurization unit 4. In the present example, the pressurization adjustment unit 5 may vary the width dimension of the contact region CN by changing the pressurization load, to form at least a plurality of different contact regions CN including the minimum contact region CN_{S} and having different width dimensions.

Next, for example, a typical aspect or a desired aspect of the heating device 11 according to the present exemplary embodiment will be described.

In the present example, as a typical aspect of the pressurization unit 4, there is an aspect in which a pressurization member rotatably provided to face the heat generation unit 2 with the heated unit 1 interposed therebetween is provided. In addition, as another aspect, there is an aspect in which a pressing member that presses the heat generation unit 2 against the heated unit 1 is provided.

In addition, in an aspect in which the heated unit 1 comes into contact with the contact region CN or the heating target medium S moving on a downstream side in a rotation direction of the contact region CN, to heat the heating target medium S, as the heat generation unit 2, it is necessary to have a plurality of heat generation resistors 3 disposed to include a maximum width region in an intersection direction intersecting with the movement direction of the heating target medium S.

In this case, as shown in FIG. 1B, the heat generation unit 2 may include the plurality of heat generation resistors 3 that heat the heating target medium S moving about a center reference line Lc passing through a center in the intersection direction intersecting with the rotation direction of the heated unit 1.

In an aspect in which the heat generation unit 2 includes the two heat generation resistors 3 (3a and 3b), in a case where the heated unit 1 heats a heating target medium S moving about a center reference line Lc passing through a center in the intersection direction intersecting with the rotation direction of the heated unit 1, and as shown in FIG. 1B, the first heat generation resistor 3a that is one of the plurality of heat generation resistors 3 may form the high heat generation portion 6 in a region including a center in the longitudinal direction of the contact region CN, and may form the low heat generation portion 7 to be close to an end portion in the longitudinal direction with the high heat generation portion 6 interposed therebetween.

Further, the second heat generation resistor 3b may form the low heat generation portion 7 in a region corresponding to the high heat generation portion 6 of the first heat generation resistor 3a, and may form the high heat generation portion 6 in a region corresponding to the low heat generation portion 7 of the first heat generation resistor 3a.

In an aspect in which, in a case where the heated unit 1 heats the heating target medium S moving about the center reference line Lc, the heat generation unit 2 includes three heat generation resistors 3 (specifically, the first heat generation resistor 3a, the second heat generation resistor 3b, and a third heat generation resistor (not shown)), from the viewpoint of efficiently heating the heating target medium S of each size, as shown in FIG. 1B, the first heat generation resistor 3a may form the high heat generation portion 6 in a region including the center in the longitudinal direction of the contact region CN, and may form the low heat generation portion 7 to be close to the end portion in the longitudinal direction with the high heat generation portion 6 interposed therebetween, the second heat generation resistor 3b may form the low heat generation portion 7 in a region corresponding to the high heat generation portion 6 of the first heat generation resistor 3a, and may form the high heat generation portion 6 in a region corresponding to the low heat generation portion 7 of the first heat generation resistor 3a, and the third heat generation resistor (not shown) may form the high heat generation portion 6 in a region including the center in the longitudinal direction of the contact region CN and being narrower than the high heat generation portion 6 of the first heat generation resistor 3a, and may form the low heat generation portion 7 to be close to the end portion in the longitudinal direction with the high heat generation portion 6 interposed therebetween. In this aspect, the third heat generation resistor (not shown) may be used mostly for heating the medium S having a small size, and the first heat generation resistor 3a and the second heat generation resistor 3b may be used in a case of a standing-up operation and in a case of heating the medium S having a size other than the small size. A combination of the patterns of the first heat generation resistor 3a to the third heat generation resistor may be appropriately selected.

In addition, as the pattern of the heat generation resistor 3, from the viewpoint of not rapidly changing the heat generation amount pattern between the high heat generation portion 6 and the low heat generation portion 7 as shown in FIG. 1B, for example, an aspect is desired in which the high heat generation portion 6 and the low heat generation portion 7 are formed in a row via a coupling heat generation portion 8 in which a width dimension gradually changes.

In the present example, examples of the aspect in which the coupling heat generation portion 8 include an aspect in which the coupling heat generation portion 8 is formed in a mountain-shape in which a width dimension linearly changes.

In addition, examples of a typical aspect of the heat generation unit 2 include an aspect in which the heat generation unit 2 includes an elongated substrate (not shown), and the plurality of heat generation resistors 3 formed along a longitudinal direction of the substrate.

In the present example, examples of an aspect of the heat generation unit 2 include an aspect in which the plurality of heat generation resistors 3 are formed along the longitudinal direction on a surface of the substrate on the heated unit 1 side, and the plurality of heat generation resistors 3 are covered with a heat-resistant protective layer (not shown).

In addition, in an aspect in which the heated unit 1 comes into contact with the contact region CN or the heating target medium S moving on a downstream side in the rotation direction of the contact region CN, to heat the heating target medium S, in a case where the heated unit 1 is heated without causing the heating target medium S to pass, for example, it is desired that the pressurization unit 4 forms the minimum contact region CN_{S}, and the heat generation unit 2 causes at least two heat generation resistors 3 (3a and 3b) including the high heat generation portion 6 in the range of the minimum contact region CN_{S} among the plurality of heat generation resistors 3 to generate heat.

Further, in the present example, in a case where the heated unit 1 is heated by causing the heating target medium S to pass, the pressurization unit 4 may form a contact region CN wider than the minimum contact region CN_{S}, and the heat generation unit 2 may cause the plurality of heat generation resistors 3 to generate heat in combination depending on a width dimension in an intersection direction intersecting with a movement direction of the heating target medium S.

Hereinafter, the present invention will be described in more detail based on the exemplary embodiments shown in the accompanying drawings.

### Exemplary Embodiment 1

### Overall Configuration of Image Formation System

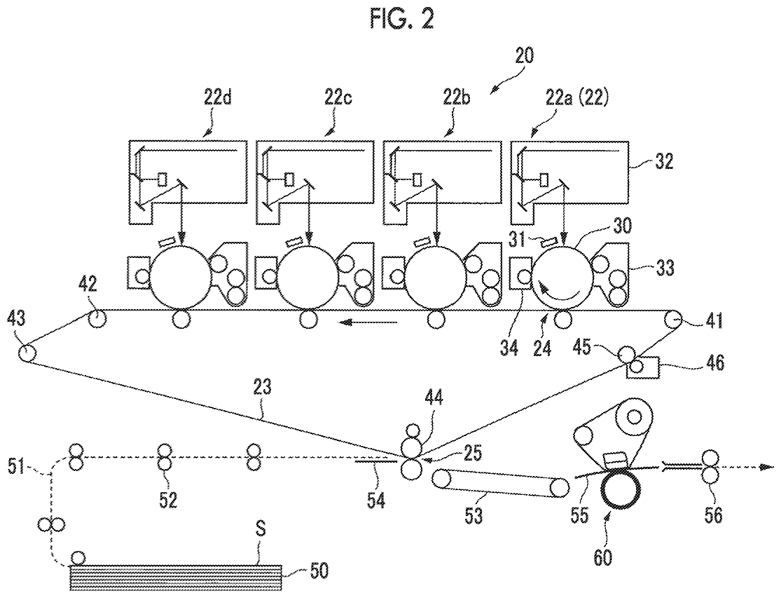

FIG. 2 is an explanatory diagram showing an overall configuration of the heat treatment system according to Exemplary Embodiment 1.

In FIG. 2, the heat treatment system is configured as an image formation system 20 including an image formation unit as a treatment unit that forms an unfixed image on the heating target medium S (hereinafter, referred to as a medium S in the exemplary embodiment) and a fixing device as a heating device that fixes the unfixed image formed on the medium S.

In the present example, the image formation system 20 is an intermediate transfer type image formation system called a so-called tandem type, and is equipped with each component as the image formation unit (not shown) and the fixing device in a common unit. Of course, an aspect may be adopted in which the image formation unit and the fixing device are configured as separate units and a plurality of units are combined.

In the present example, the image formation system 20 includes a plurality of image formation sections 22 (22a to 22d) in which a toner image of each color component (four colors of yellow (Y), magenta (M), cyan (C), and black (K) in the present example) is formed by an electrophotographic method. A belt-shaped intermediate transfer body 23 is disposed at a portion corresponding to each image formation section 22. A first-order transfer device 24 (first-order transfer roll in the present example) is disposed on the back of the intermediate transfer body 23 corresponding to each image formation section 22. Further, a second-order transfer device 25 (in the present example, second-order transfer roll) is disposed, at a part of the intermediate transfer body 23, and the second-order transfer device 25 transfers the toner image of each color component, which is primarily transferred from the image formation section 22 to the intermediate transfer body 23 by the first-order transfer device 24, to the medium S such as paper. A fixing device 60 is disposed on a downstream side in the transport direction of the medium S on which the color component toner image is transferred, and an unfixed toner image (corresponding to an unfixed image) on the medium S is fixed.

In the present example, the plurality of image formation sections 22, the intermediate transfer body 23, the first-order transfer device 24, and the second-order transfer device 25 correspond to an image formation unit for forming the unfixed image on the medium S.

### Image Formation Section

Here, each image formation section 22 has a drum-shaped photoconductor 30 that rotates in a predetermined direction, and a charging device 31 that charges the photoconductor 30, an exposure device 32 such as a laser scanning device that writes an electrostatic latent image on the photoconductor 30 charged by the charging device 31, a developing device 33 that develops the electrostatic latent image written on the photoconductor 30 by the exposure device 32 with a corresponding color toner, and a cleaning device 34 that cleans residues on the photoconductor 30 after the toner image developed by the developing device 33 is primarily transferred onto the intermediate transfer body 23 by the first-order transfer device 24 are provided around the photoconductor 30.

### Periphery of Intermediate Transfer Body

Further, the intermediate transfer body 23 is hung on a plurality of tension rolls 41 to 45, and for example, causes the tension roll 41 to rotate in a circulating manner in a predetermined direction as a drive roll. Further, the tension roll 44 also serves as a facing roll of the second-order transfer roll as the second-order transfer device 25, and generates a second-order transfer electric field for the second-order transfer between the second-order transfer roll and the facing roll. Further, an intermediate transfer cleaning device 46 is disposed on a surface of the intermediate transfer body 23 corresponding to the tension roll 45.

### Medium Transport System

Further, a medium supply device 50 is provided below the intermediate transfer body 23, and the medium S supplied from the medium supply device 50 is transported along a transport path 51 to the fixing device 60 through the second-order transfer device 25. On the transport path 51, an appropriate number of transport rolls 52 or a transport belt 53 for the transportation from the second-order transfer device 25 to the fixing device 60, further, guide plates 54 and 55 that guide the medium S to a second-order transfer part by the second-order transfer device 25 and a fixing part of the fixing device 60, respectively, a discharge roll 56 for discharging the medium S to a medium discharge unit (not shown), and the like are provided.

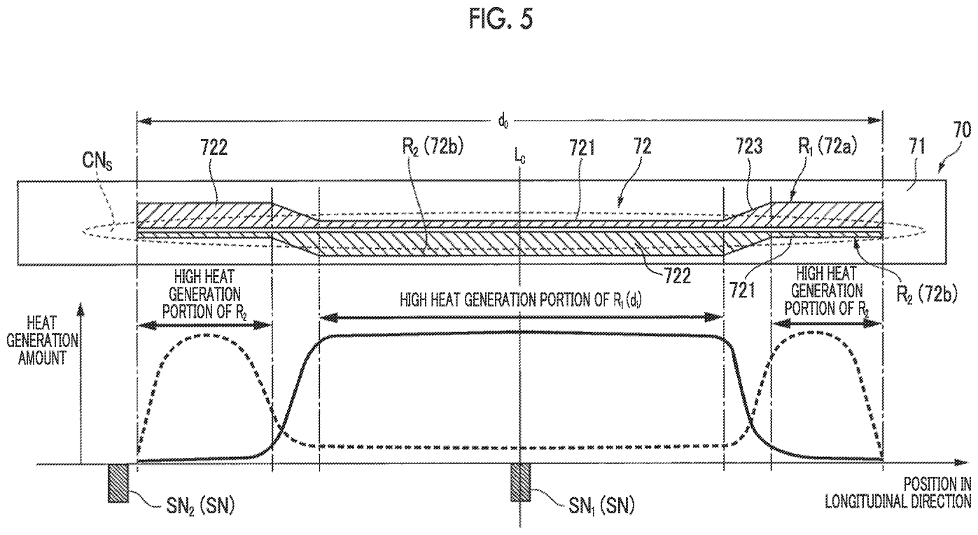

In the present example, a method is adopted in which the medium S moves about the center reference line Lc (see FIG. 5) passing through the center of the medium S in the intersection direction (typically, the width direction) intersecting with the transport direction.

### Overall Configuration of Fixing Device

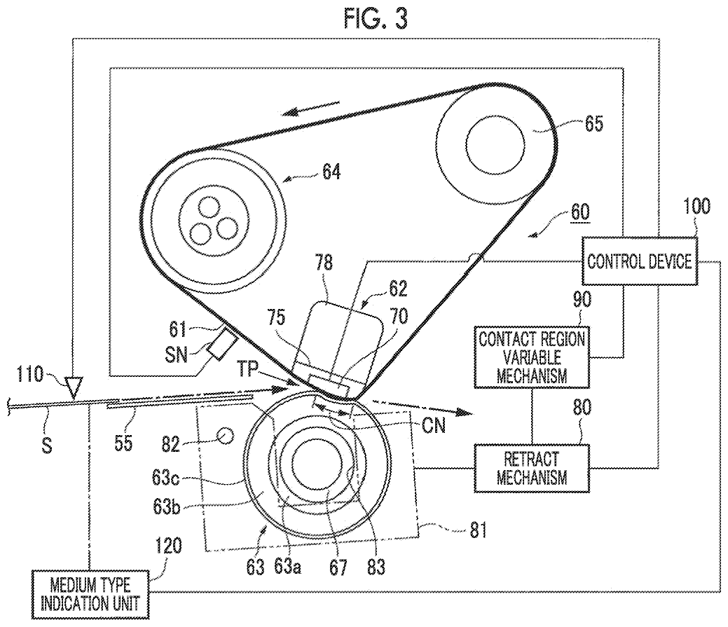

Next, the fixing device 60 used in the present exemplary embodiment will be described with reference to FIG. 3.

In FIG. 3, the fixing device 60 has a width dimension necessary for fixing the medium S moving in the transport direction. The fixing device 60 includes a fixing belt 61 as the heated unit rotates in a circulating manner, a heat generation component 62 as the heat generation unit that is provided in contact with the back surface side of the fixing belt 61 and heats the fixing belt 61, a pressurization roll 63 that is provided in contact with a part facing the heat generation component 62 with the fixing belt 61 interposed therebetween and pressurizes the fixing belt 61 to form the contact region CN between the pressurization roll 63 and the fixing belt 61, an upstream tension roll 64 that stretches the fixing belt 61 to be rotatable in a circulating manner on a side of the fixing belt 61 on an upstream side of the contact region CN in the movement direction, and a downstream tension roll 65 that stretches the fixing belt 61 to be rotatable in a circulating manner on a side of the fixing belt 61 on a downstream side of the contact region CN in the movement direction.

### Configuration Example of Fixing Belt

In the present example, the fixing belt 61 is an endless heat conduction belt having flexibility and heat resistance. As the fixing belt 61, a belt molded into a cylindrical shape using a material such as synthetic resin, for example, polyimide or polyamide is applied.

In the present example, one of the upstream tension roll 64 or the downstream tension roll 65 (in the present example, the downstream tension roll 65) functions as a drive roll that is rotationally driven by a drive motor (not shown). In addition, the tension roll 63 functions as a tension applying roll that applies tension to the fixing belt 61, in which the other of the upstream tension roll 64 or the downstream tension roll 65 (in the present example, the upstream tension roll 64) applies tension to the fixing belt 61. From the viewpoint of preventing the fixing belt 61 from being biased, of course, the upstream tension roll 64 may be supported to be inclinable and may function as a steering roll.

### Heat Generation Component

In the present example, the heat generation component 62 directly heats the back surface of the fixing belt 61, and heats the medium S, which is interposed on the contact region CN between the fixing belt 61 and the pressurization roll 63 and is pressurized and transported, via the fixing belt 61.

In the present example, the heat generation component 62 includes a long plate-shaped planar heater 70 that is disposed on the back surface side of the fixing belt 61 corresponding to the contact region CN and extends in the width direction intersecting with the transport direction of the medium S, and a heater holder 75 that holds the planar heater 70, and the heater holder 75 is fixed at a predetermined position via a support bracket 78.

### Configuration Example of Planar Heater

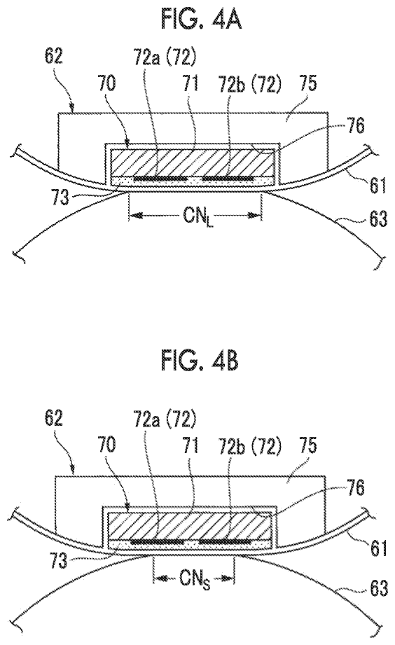

In the present example, as shown in FIG. 4A, the planar heater 70 is positioned and accommodated in a recess 76 formed in the heater holder 75 and is fixed by a fixing tool. The planar heater 70 includes a long substrate 71, a plurality of heat generation resistors 72 that are provided on a side surface of the substrate 71, which is in contact with an inner peripheral surface of the fixing belt 61, and extend in the longitudinal direction of the substrate 71, a wiring electrode (not shown) that is provided on the substrate 71 in the vicinity of both end portions of the heat generation resistor 72 in the longitudinal direction and is for supplying power to the heat generation resistor 72, and an insulating layer 73 that is laminated on the surface of the substrate 71, which is on the fixing belt 61 side, to cover the heat generation resistor 72 and the wiring electrode.

Here, the substrate 71 is a rectangular plate-shaped member in which the length dimension in the width direction intersecting with the transport direction of the medium S is longer than the maximum size. The substrate 71 is made of a material having electrical insulation, and for example, a ceramic substrate is used as the substrate 71. Further, the insulating layer 73 may be appropriately selected, but for example, glass is used.

### Configuration Example of Heat Generation Resistor

In addition, in the present example, the heat generation resistor 72 is, for example, a band-shaped heat generation resistor which has a predetermined resistance value and is formed by printing and baking a metal paste containing a silver (Ag)/palladium (Pd) alloy as a major component.

In addition, in the present example, the heat generation resistor 72 includes a plurality (two in the present example) of heating wire portions 72a and 72b extending linearly along the longitudinal direction on one surface of the substrate 71, and the heating wire portions 72a and 72b are disposed at intervals in the lateral direction of the substrate 71.

Here, in a case where the heating wire portion 72a of the heat generation resistor 72 is a first heat generation resistor R1 and the heating wire portion 72b is a second heat generation resistor R2, as shown in FIG. 5, the first and second heat generation resistors R1 and R2 are configured in the following pattern.

The lengths do in the longitudinal direction of the first and second heat generation resistors R1 and R2 are selected to include, for example, a width dimension (for example, a lateral dimension of paper of A4 size of JIS standard) intersecting with the transport direction of the medium size used.

The line widths of the first and second heat generation resistors R1 and R2 are set as follows in accordance with the regions in the longitudinal direction.

The first heat generation resistor R1 is set as a high heat generation portion 721 in which the line width of the heat generation material in the region is small and the electrical resistance is large so that the region having a length d1 (for example, the lateral dimension of the paper of the A5 size of JIS standard) on the right and left sides with the center (center reference line Lc) of the heat generation region in the longitudinal direction as a reference generates heat with a high heat generation amount. In addition, the first heat generation resistor R1 is set as a low heat generation portion 722 in which the line width of the heat generation material is large and the electrical resistance is small so that the region of the high heat generation portion 721 located at both end portions of the heat generation region does not generate heat.

The second heat generation resistor R2 is set as the low heat generation portion 722 in which the line width of the heat generation material in the region is large and the electrical resistance is small so that the region having the length d1 on the right and left sides with the center (center reference line Lc) of the heat generation region in the longitudinal direction as a reference does not generate heat. In addition, the second heat generation resistor R2 is set as the high heat generation portion 721 in which the line width of the heat generation material is small and the electrical resistance is large so that the region of the low heat generation portion 722 located at both end portions of the heat generation region generates heat with a high heat generation amount.

Further, in the present example, as the first and second heat generation resistors R1 and R2, an aspect is adopted in which the high heat generation portion 721 and the low heat generation portion 722 are formed in a row via a coupling heat generation portion 723 in which the width dimension gradually changes so that the heat generation amount pattern is not abruptly changed between the high heat generation portion 721 and the low heat generation portion 722. Here, for example, an aspect is used in which the coupling heat generation portion 723 is formed in a mountain-shape in which the width dimension linearly changes.

As described above, in the present example, the high heat generation portion 721 and the low heat generation portion 722 are formed in a row in both the first and second heat generation resistors R1 and R2, but the high heat generation portion 721 and the low heat generation portion 722 are in a positional relationship in which the high heat generation portion 721 and the low heat generation portion 722 are opposite to each other in the longitudinal direction. Therefore, as shown in FIG. 5, the heat generation amounts of the first and second heat generation resistors R1 and R2 at the positions in the longitudinal direction are added up, and thus substantially uniform heat generation amounts are obtained.

### Pressurization Roll

Further, as the pressurization roll 63, as shown in FIG. 3, a material in which an elastic material 63b such as urethane rubber is laminated around a metal roll 63a is used, and a protective layer 63c is laminated on the surface of the elastic material.

In the present example, in the pressurization roll 63, both end shaft portions of the metal roll 63a are rotatably supported via a bearing 67.

Further, in the present example, the pressurization roll 63 is brought into contact with and separated from a set position at which the pressurization roll is in contact with the fixing belt 61 via a retract mechanism 80 and a retract position at which the pressurization roll is not in contact with the fixing belt 61. In the present example, the retract mechanism 80 has a swing holding arm 81 that is swung around a swing support shaft 82, and a U-shaped groove 83 in which the bearings 67 located at both ends of the pressurization roll 63 are received is formed in the swing holding arm 81 so that the pressurization roll 63 is brought into contact with and separated from the swing holding arm.

### Contact Region Variable Mechanism

In the present example, as shown in FIG. 3, a contact region variable mechanism 90 that varies the width dimension of the contact region CN along the transport direction of the medium S is provided.

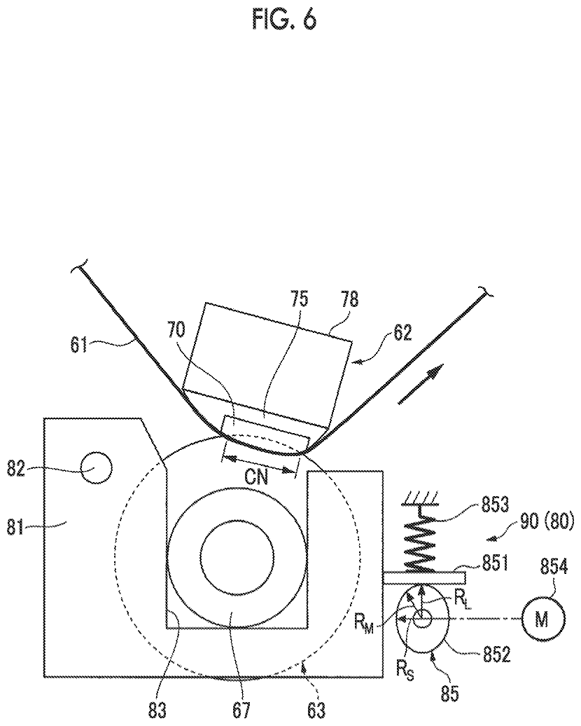

FIG. 6 shows an example of the contact region variable mechanism 90 used in Exemplary Embodiment 1.

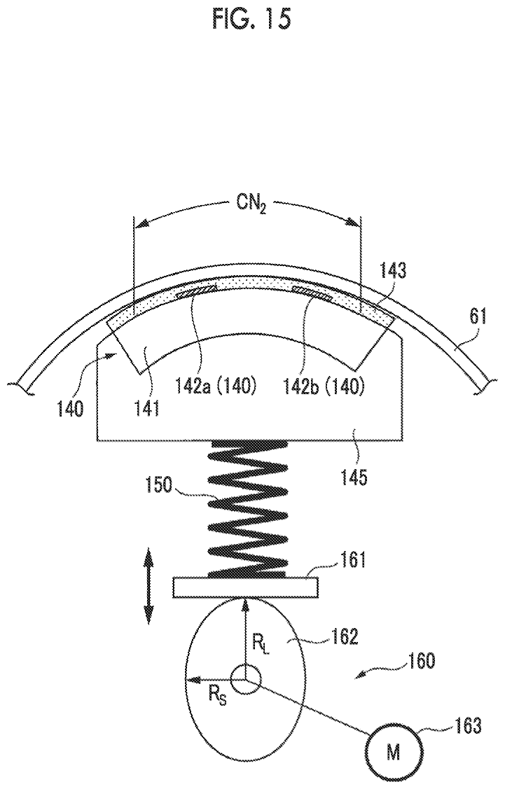

In FIG. 15, the contact region variable mechanism 90 is configured by using the retract mechanism 80 of the pressurization roll 63.

In the present example, the retract mechanism 80 has a contact and separation mechanism 85 for bringing the pressurization roll 63 into contact with the fixing belt 61 and separating the pressurization roll 63 from the fixing belt 61. The contact and separation mechanism 85 is a mechanism that protrudes a protruding piece 851 on the free end side of the swing holding arm 81, disposes an eccentric cam 852 in contact with the lower side of the protruding piece 851, is provided with a biasing spring 853 that biases the protruding piece 851 to the eccentric cam 852 side on the side of the protruding piece 851 opposite to the eccentric cam 852, and switches and rotates the eccentric cam 852 to a long diameter position RL and a short diameter position RS by a drive motor 854.

In the present example, in the retract mechanism 80, in a case where the short diameter position RS of the eccentric cam 852 abuts on the protruding piece 851, the pressurization roll 63 is retracted to the retract position, and in a case where the long diameter position RL of the eccentric cam 852 abuts on the protruding piece 851, the pressurization roll 63 is disposed at the set position.

In the present example, the contact region variable mechanism 90 uses a middle diameter position other than the long diameter position RL and the short diameter position RS of the eccentric cam 852 in the contact and separation mechanism 85 of the retract mechanism 80, and rotates the pressurization roll 63 around the swing support shaft 82 of the swing holding arm 81 to vary the width dimension of the contact region CN.

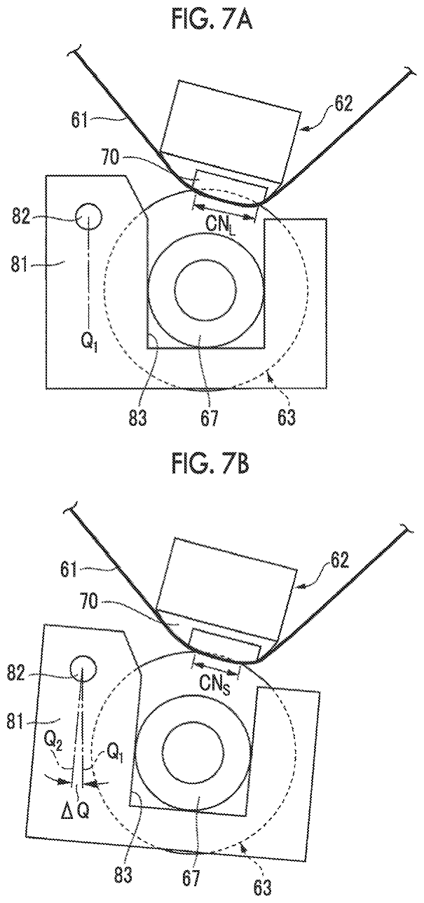

In the present example, in a case where the long diameter position RL of the eccentric cam 851 abuts on the protruding piece 852, the pressurization roll 63 is disposed at the set position. In this state, it is assumed that the pressurization roll 63 is disposed such that the wide contact region CN_{L} used during normal printing is secured as shown in FIG. 7 (see FIG. 4A). A posture position of the swing holding arm 81 is indicated by Q1 in FIG. 7.

On the other hand, as shown in FIG. 7, in a case where the drive motor 854 is stopped at a position at which a middle diameter position RM (RS<RM<RL) of the eccentric cam 852 abuts on the protruding piece 851, the posture position of the swing holding arm 81 is in a state of being inclined from Q1 to Q2 by ΔQ, and thus the pressurization roll 63 is disposed so that the minimum contact region CN_{S} being narrow and having the minimum width dimension is secured (FIG. 4B).

Although, in the present example, although the contact region CN is shown to change into two regions, that is, the wide normal contact region CN_{L} and the narrow minimum contact region CN_{S}, the present invention is not limited to this. Of course, the contact region CN located between the wide normal contact region CN_{L} and the narrow minimum contact region CN_{S} may be more appropriately selected depending on the physical property and the size of the medium.

### Relationship Between Change of Contact Region and Pattern of Heat Generation Resistor

As described above, the contact region CN between the fixing belt 61 and the pressurization roll 63 changes to the wide normal contact region CN_{L} and the narrow minimum contact region CN_{S} by the contact region variable mechanism 90.

In this state, the positions of the high heat generation portions 721 of the first and second heat generation resistors R1 and R2 are adjusted to be included in the contact region CN in any case of the wide contact region CN_{L} or the narrow minimum contact region CN_{S}.

### Peripheral Structure of Fixing Device

In the present example, as shown in FIGS. 3 and 5, a surface temperature sensor SN that detects the temperature of the surface of the fixing belt 61 on the upstream side in the rotation direction with respect to the contact region CN is provided. The surface temperature sensor SN may be appropriately selected from known sensors such as a thermistor and a temperature measurement resistor.

In the present example, two surface temperature sensors are used as the surface temperature sensor SN.

A surface temperature sensor SN1 that is one of the two surface temperature sensors detects the temperature of the surface of the fixing belt 61 corresponding to the medium passage region. In the present example, the temperature of the surface of the fixing belt 61 in the vicinity of the center reference line Lc is detected.

A surface temperature sensor SN2 that is the other of the two surface temperature sensors detects the temperature of the surface of the fixing belt 61 corresponding to the medium non-passage region.

In addition, a position sensor 110 that detects the position of the medium S is provided on the upstream side of the fixing device 60 in the transport direction of the medium S in the transport path 51. The position sensor 110 is used to start counting of a timer counter and to determine the position of the medium S by detecting a leading end or a trailing end of the transported medium S.

Further, a medium type indication unit 120 indicates physical property information such as the size and the thickness of the medium S to be transported, but the size or physical property information of the medium S may be detected during the transportation of the medium S, and the detected information may be used as the indication information.

### Control System of Fixing Device

In FIG. 3, the reference numeral 100 denotes a control device including a microcomputer including various processors.

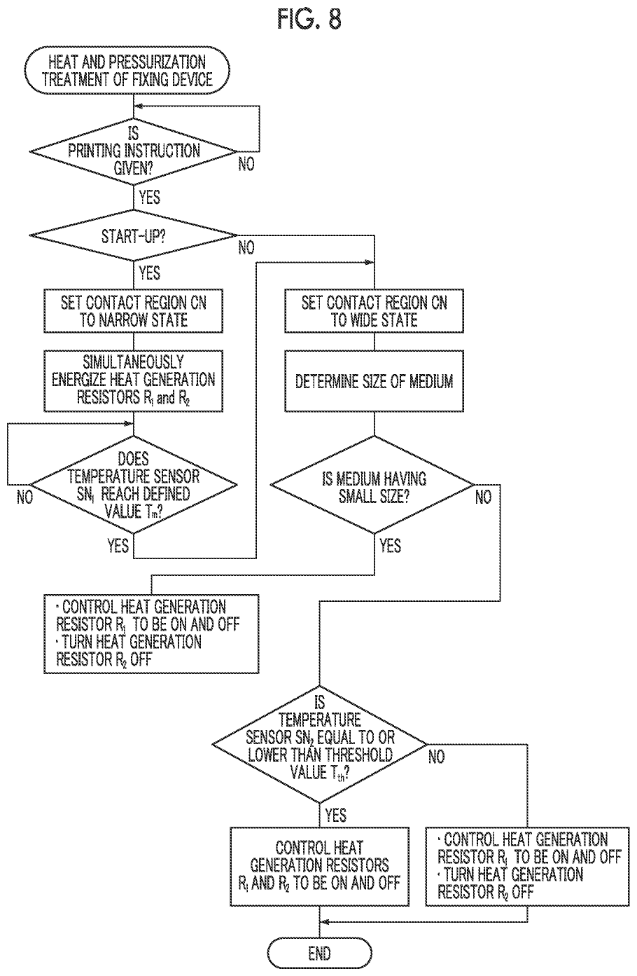

In the present example, a control device 100 installs a heat and pressurization treatment program (see FIG. 8) of the fixing device in advance in a memory (not shown), incorporates operation signals from an operation panel (not shown), and each information from the position sensor 110, the surface temperature sensor SN, and the medium type indication unit 120 into the processor, executes various programs in the processor, and controls predetermined control signals to the planar heater 70, the retracting mechanism 80, the contact region variable mechanism 90, and the like.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

### Heat and Pressurization Treatment of Fixing Device

In a case where it is assumed that a printing instruction is given from the operation panel (not shown), the control device 100 executes the series of image forming processes.

In a case where the fixing device 60 receives the printing instruction but a heating condition of the fixing device and a pressurization condition of the pressurization roll 63 are not yet prepared, a start-up operation is performed on the fixing device 60. Here, in a case where the control device 100 determines that the start-up is performed, the contact region CN is set to a narrow state by using the contact region variable mechanism 90. That is, the contact region CN is set to the minimum contact region CN_{S} (see FIGS. 4B and 5).

In this state, the control device 100 simultaneously energizes the first and second heat generation resistors R1 and R2 until the fixing belt 61 reaches a predetermined defined value Tm (corresponding to a temperature required for a fixing operation) while monitoring the temperature information from the surface temperature sensor SN1, and heats the fixing belt 61.

In this type of the start-up operation, the high heat generation portions 721 of the first and second heat generation resistors R1 and R2 heat the fixing belt 61 with a high heat generation amount in the minimum contact region CN_{S}, and thus the heat treatment of the fixing belt 61 is performed efficiently in a short time.

In this case, the high heat generation portions 721 of the first and second heat generation resistors R1 and R2 are not outside the range of the minimum contact region CN_{S}, and thus the periphery of the minimum contact region CN_{S} is not excessively heated.

Next, in a case where the start-up operation of the fixing device 60 is completed, the control device 100 sets the contact region CN to a wide state. That is, the contact region CN is set to the normal contact region CN_{L} during printing.

In this state, the control device 100 performs a fixing treatment appropriate for printing. That is, the control is performed as follows so that the temperature acquired by the surface temperature sensor SN1 is set to a constant value such that the fixing state is good in the medium passage region in the longitudinal direction, and the temperature acquired by the surface temperature sensor SN2 is not equal to or higher than a threshold value Tth such that the temperature in the medium non-passage region in the longitudinal direction is not higher than the heat-resistant temperature of the various members.
In a case where printing is performed on a medium having a small size (for example, A5 size of JIS standard), the first heat generation resistor R1 is controlled to be on and off, and the second heat generation resistor R2 is turned off.
In a case where printing is performed on a medium having a size larger than the small size,
(i) in a case where the temperature acquired by the surface temperature sensor SN2 is equal to or lower than the threshold value Tth, the first and second heat generation resistors R1 and R2 are controlled to be on and off, and
(ii) in a case other than (i), the first heat generation resistor R1 is controlled to be on and off, and the second heat generation resistor R2 is turned off.

### Comparative Form 1-1

In evaluating the performance of the fixing device according to the present exemplary embodiment, a fixing device according to Comparative Form 1-1 will be described.

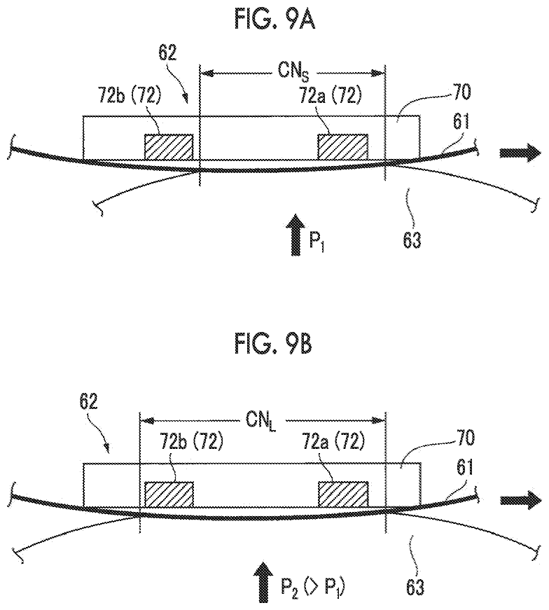

As shown in FIG. 9A, it is assumed that the contact region CN is set to the narrow minimum contact region CN_{S} by pressurizing the pressurization roll 63 with a pressurization load P1, and among the first and second heat generation resistors R1 and R2, for example, the first heat generation resistor R1 is disposed in a state of being outside the range of the minimum contact region CN_{S}.

In this case, in a case where the first heat generation resistor R1 that is outside the minimum contact region CN_{S} generates heat, the fixing belt 61 outside the minimum contact region CN_{S} is disposed in a state of being not in contact with the pressurization roll 63. Therefore, the heat of the fixing belt 61 heated by the first heat generation resistor R1 does not move to the pressurization roll 63, so that the temperature around the minimum contact region CN_{S} of the fixing belt 61 abnormally rises.

In order to eliminate such a problem, as shown in FIG. 9B, it is necessary to increase the pressurization load P1 on the pressurization roll 63 to P2 (>P1) so that the first and second heat generation resistors R1 and R2 are included in the range of the wide contact region CN_{L}. Therefore, it is difficult to reduce the pressurization load.

### Modification Form 1-1

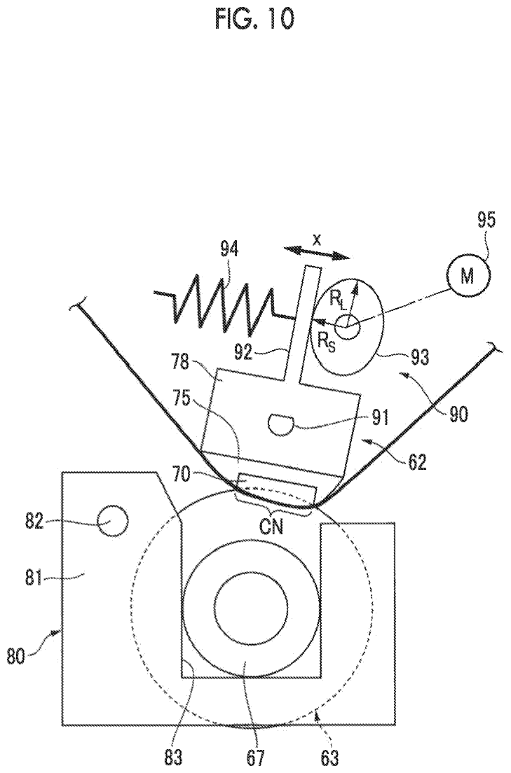

In the present exemplary embodiment, although the contact region variable mechanism 90 adopts a method of moving the pressurization roll 63 with respect to the fixing belt 61, the present invention is not limited to this, and the contact region variable mechanism 90 can be configured as shown in FIG. 10.

In the present example, the contact region variable mechanism 90 protrudes guide projections 91 that are D-cut at both end portions of the support bracket 78 of the heat generation component 62 in the longitudinal direction, and disposes support frames (not shown) on both sides of the guide projection 91. The contact region variable mechanism 90 forms a long hole (not shown) extending in the width direction of the contact region CN along the transport direction of the medium S in the support frame, fits the guide projection 91 slidably (slidingly) into the long hole, and disposes the heat generation component 62 to be linearly movable in the width direction (the x direction in the drawing) of the contact region CN.

Further, the contact region variable mechanism 90 is provided with a protruding piece 92 that extends in a direction orthogonal to the width direction of the contact region CN in a part of the support bracket 78, and disposes the eccentric cam 93 in contact with the protruding piece 92. The contact region variable mechanism 90 disposes a biasing spring 94 that biases the protruding piece 92 to the eccentric cam 93 side on the side of the eccentric cam 93 opposite to the protruding piece 92, and switches and rotates the eccentric cam 93 to the long diameter position RL and the short diameter position RS by the drive motor 95.

In the present example, as shown in FIG. 10, in a case where the short diameter position RS of the eccentric cam 93 abuts on the protruding piece 92, the heat generation component 62 is disposed so that the wide contact region CN_{L} used during normal printing is secured.

On the other hand, as shown in FIG. 10, in a case where the long diameter position RL of the eccentric cam 93 abuts on the protruding piece 92, the heat generation component 62 is moved to the inlet side of the medium S along the width direction (x direction in FIG. 10) of the contact region CN and is disposed so that the narrow minimum contact region CN_{S} is secured.

### Modification Form 1-2

In the present exemplary embodiment, in the planar heater 70 of the heat generation component 62, the patterns (high heat generation portion 721 and low heat generation portion 722) of the first and second heat generation resistors R1 and R2 are set on the assumption of a method (center reference method) in which the medium S is transported with the center (center reference line Lc) in the width direction of the medium S as a reference.

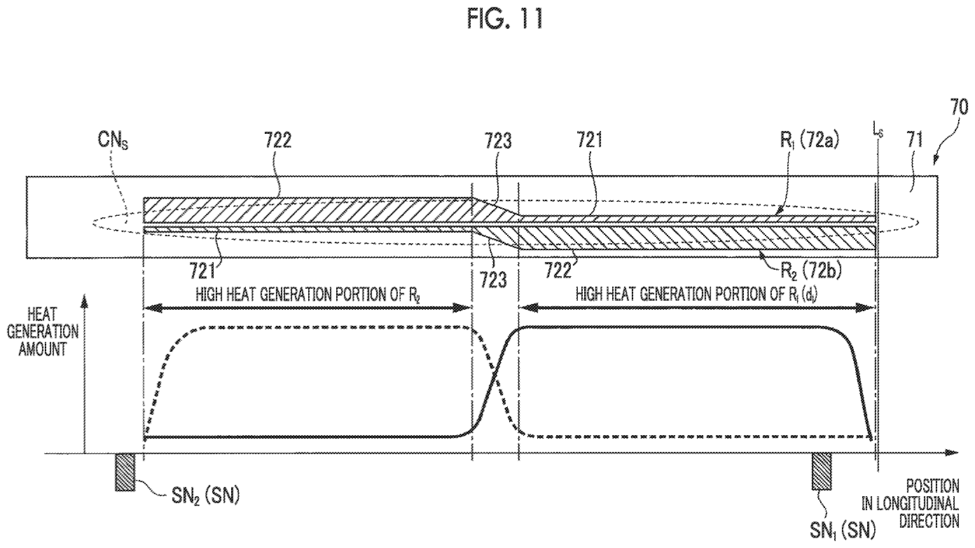

However, as shown in FIG. 11, in a case where a method (side reference method) in which the medium S is transported with one side (side reference line Ls) in the width direction of the medium S as a reference is assumed, a passage region of the medium S having a different size in the fixing belt 61 is different from the center reference method.

Therefore, in the side reference method shown in FIG. 11, the patterns of the first and second heat generation resistors R1 and R2 are configured as follows because the medium S having a small size passes through the side reference line Ls of the fixing belt 61.

As shown in FIG. 11, the first heat generation resistor R1 is set as a high heat generation portion 721 in which the line width of the heat generation material in the region is small and the electrical resistance is large so that the region having a length d1 (for example, the lateral dimension of the paper of A5 size of JIS standard) with one side (side reference line Ls) of the heat generation region in the longitudinal direction as a reference generates heat with a high heat generation amount. In addition, the first heat generation resistor R1 is set as the low heat generation portion 722 in which the line width of the heat generation material is large and the electrical resistance is small so that the region of the high heat generation portion 721 located on the opposite side to the heat generation region does not generate heat.

The second heat generation resistor R2 is set as the low heat generation portion 722 in which the line width of the heat generation material in the region is large and the electrical resistance is small so that the region having the length d1 with one side (side reference line Ls) of the heat generation region in the longitudinal direction as a reference does not generate heat. In addition, the second heat generation resistor R2 is set as the high heat generation portion 721 in which the line width of the heat generation material is small and the electrical resistance is large so that the region of the low heat generation portion 722 located on the opposite side to the heat generation region generates heat with a high heat generation amount.

In the present example, both the first and second heat generation resistors R1 and R2 have an aspect in which the high heat generation portion 721 and the low heat generation portion 722 are formed in a row via the coupling heat generation portion 723.

As described above, even in the present example, the high heat generation portion 721 and the low heat generation portion 722 are formed in a row in both the first and second heat generation resistors R1 and R2, but the high heat generation portion 721 and the low heat generation portion 722 are in a positional relationship in which the high heat generation portion 721 and the low heat generation portion 722 are opposite to each other in the longitudinal direction. Therefore, in a case where the heat generation amounts of the first and second heat generation resistors R1 and R2 at the positions in the longitudinal direction are added up, a substantially uniform heat generation amount is obtained.

### Exemplary Embodiment 2

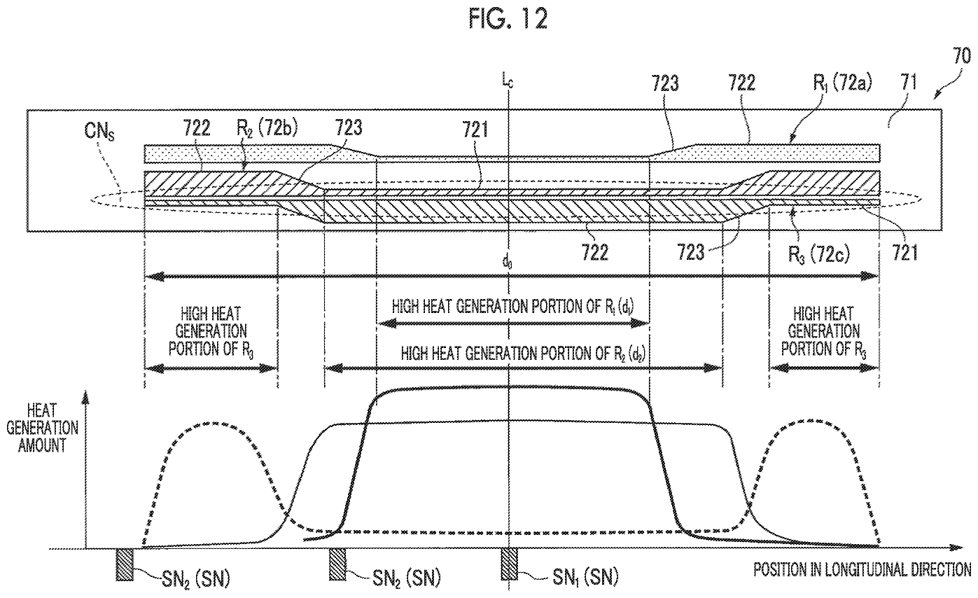

FIG. 12 is an explanatory diagram showing patterns and heat generation amounts of a plurality of heat generation resistors of a heat generation component of a fixing device according to Exemplary Embodiment 2.

In FIG. 12, the heat generation component 62 is the same as the heat generation component in Exemplary Embodiment 1 in that the planar heater 70 is held by the heater holder 75, but the number and the patterns of the heat generation resistors 72 of the planar heater 70 are different from Exemplary Embodiment 1. The components that are the same as the components in Exemplary Embodiment 1 will be denoted by the same reference numerals as in Exemplary Embodiment 1, and the detailed description thereof will be omitted herein.

In the present example, the heat generation resistor 72 includes a plurality (three in the present example) of heating wire portions 72a, 72b, and 72c extending linearly along the longitudinal direction on one surface of the substrate 71, and the heating wire portions 72a, 72b, and 72c are disposed at intervals in the lateral direction of the substrate 71.

Here, in a case where the heating wire portion 72a of the heat generation resistor 72 is the first heat generation resistor R1, the heating wire portion 72b is the second heat generation resistor R2, and the heating wire portion 72c is a third heat generation resistor R3, the first to third heat generation resistors R1, R2, and R3 are configured in the following patterns as shown in FIG. 12.

The lengths in the longitudinal direction of the first to third heat generation resistors R1, R2, and R3 are set to a length d0 (for example, a lateral dimension of one size larger than A3 size of the JIS standard) corresponding to the maximum size of the medium S determined in advance. The line width is set as follows in each region in the longitudinal direction.

The first heat generation resistor R1 is set as the high heat generation portion 721 in which the line width of the heat generation material in the region is small and the electrical resistance is large so that the region having a length d1 (for example, the lateral dimension of the paper of A5 size of JIS standard) on the right and left sides with the center (center reference line Lc) of the heat generation region in the longitudinal direction as a reference generates heat with a high heat generation amount. In addition, the first heat generation resistor R1 is set as the low heat generation portion 722 in which the line width of the heat generation material is large and the electrical resistance is small so that the region of the high heat generation portion 721 located at both end portions of the heat generation region does not generate heat.

The second heat generation resistor R2 is set as a high heat generation portion 721 in which the line width of the heat generation material in the region is small and the electrical resistance is large so that the region having a length d2 (for example, the lateral dimension of the paper of B4 size of JIS standard) on the right and left sides with the center (center reference line Lc) of the heat generation region in the longitudinal direction as a reference generates heat with a high heat generation amount. In addition, the first heat generation resistor R1 is set as the low heat generation portion 722 in which the line width of the heat generation material is large and the electrical resistance is small so that the region of the high heat generation portion 721 located at both end portions of the heat generation region does not generate heat.

The third heat generation resistor R3 is set as the low heat generation portion 722 in which the line width of the heat generation material in the region is large and the electrical resistance is small so that the region having the length d2 on the right and left sides with the center (center reference line Lc) of the heat generation region in the longitudinal direction as a reference does not generate heat. In addition, the second heat generation resistor R2 is set as the high heat generation portion 721 in which the line width of the heat generation material is small and the electrical resistance is large so that the region of the low heat generation portion 722 located at both end portions of the heat generation region generates heat with a high heat generation amount.

In the present example, all of the first to third heat generation resistors R1, R2, and R3 have an aspect in which the high heat generation portion 721 and the low heat generation portion 722 are formed in a row via the coupling heat generation portion 723.

As described above, in the present example, the high heat generation portion 721 and the low heat generation portion 722 are formed in a row in all the second and third heat generation resistors R2 and R3, but the high heat generation portion 721 and the low heat generation portion 722 are in a positional relationship in which the high heat generation portion 721 and the low heat generation portion 722 are opposite to each other in the longitudinal direction. Therefore, as shown in FIG. 12, the heat generation amounts of the second heat generation resistor R2 and the third heat generation resistor R3 at the positions in the longitudinal direction are added up, and thus substantially uniform heat generation amounts are obtained.

In addition, in the present example, as in Exemplary Embodiment 1, the contact region variable mechanism 90 (FIGS. 3 and 5) that varies the width dimension of the contact region CN is provided. In the present example, mostly, two contact regions, that is, the minimum contact region CN_{S} selected at the time of the start-up of the fixing device 60 and the wide contact region CN_{L} selected at the time of normal printing are used. However, of course, the contact region CN may be used to be changed more finely depending on the physical properties and the size of the medium S.

Further, in the present example, three surface temperature sensors SN (see FIG. 3) that detect the temperature of the surface of the fixing belt 61 are used.

The surface temperature sensor SN1 that is one of the three surface temperature sensors detects the temperature of the surface of the fixing belt 61 corresponding to the medium passage region. In the present example, the temperature of the surface of the fixing belt 61 in the vicinity of the center reference line Lc is detected.

The surface temperature sensor SN2 that is another of the three surface temperature sensors detects the temperature of a region of the surface of the fixing belt 61 corresponding to the medium passage region, the region being outside the lateral dimension of the letter size paper and inside the lateral dimension of B4 size of JIS standard.

A surface temperature sensor SN3 that is the other of the three surface temperature sensors detects the temperature of the surface of the fixing belt 61 corresponding to the medium non-passage region.

### Heat and Pressurization Treatment of Fixing Device

In a case where it is assumed that a printing instruction is given from the operation panel (not shown), the control device 100 executes the series of image forming processes.

In a case where the fixing device 60 receives the printing instruction but a heating condition of the fixing device 60 and a pressurization condition of the pressurization roll 63 are not yet prepared, the start-up operation is performed on the fixing device 60.

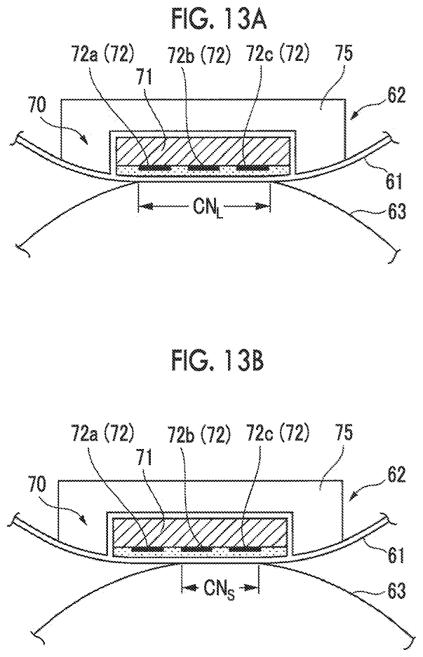

Here, in a case where the control device 100 determines that the start-up operation is performed, the contact region CN is set to a narrow state by using the contact region variable mechanism 90. That is, the contact region CN is set to the minimum contact region CN_{S} (see FIGS. 12 and 13B).

In this state, the control device 100 simultaneously energizes the second heat generation resistor R2 and the third heat generation resistor R3 until the fixing belt 61 reaches the predetermined defined value Tm (corresponding to a temperature required for the fixing operation) while monitoring the temperature information from the surface temperature sensor SN1, and heats the fixing belt 61.

In the present example, as shown in FIG. 12, the high heat generation portions 721 of the second and third heat generation resistors R2 and R3 are included in the range of the minimum contact region CN_{S}.

In this type of the start-up operation, the high heat generation portions 721 of the second and third heat generation resistors R2 and R3 heat the fixing belt 61 with a high heat generation amount in the minimum contact region CN_{S}, and thus the heat treatment of the fixing belt 61 is performed efficiently in a short time.

In this case, the high heat generation portions 721 of the second and third heat generation resistors R2 and R3 are not outside the range of the minimum contact region CN_{S}, and thus the periphery of the minimum contact region CN_{S} is not excessively heated.

In the present example, since the first heat generation resistor R1 is not used during the start-up operation, the high heat generation portion 721 of the first heat generation resistor R1 may not be included in the range of the minimum contact region CN_{S}.

Next, in a case where the start-up operation of the fixing device 60 is completed, the control device 100 sets the contact region CN to the wide state. That is, the contact region CN is set to the wide normal contact region CN_{L} during printing (see FIG. 13B). In the present example, the high heat generation portions 721 of the heat generation resistors R1, R2, and R3 are included in the wide normal contact region CN_{L}.

In this state, the control device 100 performs the fixing treatment appropriate for printing. That is, the control is performed as follows so that the temperature acquired by the surface temperature sensor SN1 is set to a constant value such that the fixing state is good in the medium passage region in the longitudinal direction, and the temperature acquired by the surface temperature sensor SN2 or SN3 is not equal to or higher than a threshold value Tth such that the temperature in the medium non-passage region in the longitudinal direction is not higher than the heat-resistant temperature of the various members.
In a case where printing is performed on a medium having a size of B4 or larger,
(i) in a case where the temperature acquired by the surface temperature sensor SN3 is equal to or lower than a certain threshold value Tth, the second and third heat generation resistors R2 and R3 are controlled to be on and off, and
(ii) in a case other than (i),
the third heat generation resistor R3 is turned off, and the second heat generation resistor R2 is controlled to be on and off.
In a case where printing is performed on a medium having a size smaller than B4size,
(i) in a case where the temperature acquired by the surface temperature sensor SN2 is equal to or lower than a certain threshold value Tth, the first and second heat generation resistors R1 and R2 are controlled to be on and off, and
(ii) in a case other than (i), the second heat generation resistor R2 is always turned off, and the first heat generation resistor R1 is turned on and off.

### Exemplary Embodiment 3

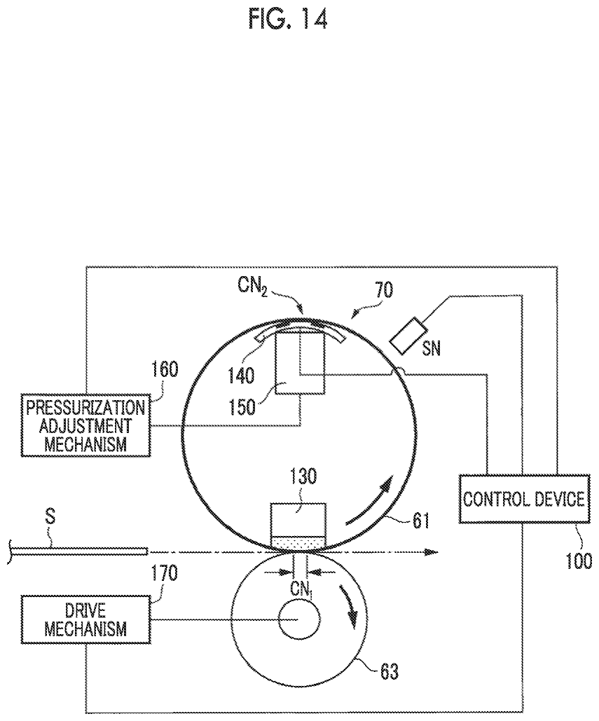

FIG. 14 shows a major part of a fixing device according to Exemplary Embodiment 3.

As shown in FIG. 14, the basic configuration of the fixing device 60 includes the fixing belt 61, the pressurization roll 63 that is provided to face a surface side of the fixing belt 61 and that pressurizes the fixing belt 61, a facing pad 130 that is provided to face the pressurization roll 63 with the fixing belt 61 interposed therebetween and forms a first contact region CN1 through which the medium S passes between the fixing belt 61 and the pressurization roll 63, a heat generation component 140 that is provided in contact with the back surface of the fixing belt 61 at a portion different from the first contact region CN1 and heats the back surface of the fixing belt 61, a biasing spring 150 that serves as a pressing unit that presses the heat generation component 140 against the fixing belt 61 side, and a pressurization adjustment mechanism 160 that changes a pressurized state of a second contact region CN2 between the heat generation component 140 and the fixing belt 61.

In the present example, the fixing belt 61 includes a cylindrical belt member and is rotatably interposed between the pressurization roll 63 and the facing pad 130 in the first contact region CN1.

The pressurization roll 63 is rotationally driven by a drive force from the drive mechanism 170, and the fixing belt 61 rotates to follow the pressurization roll 63.

Further, in the present example, the second contact region CN2 is provided at a position displaced by approximately 180° from the first contact region CN1 with respect to the fixing belt 61.

Further, as shown in FIG. 15, the heat generation component 140 includes a curved substrate 141 that extends in the width direction of the fixing belt 61 and has a cross-sectional curved shape. A curvature radius r1 (not shown) of the surface side of the curved substrate 141 is set to be shorter than a curvature radius r2 (not shown) of the inner surface of the fixing belt 61 in a free state. A plurality (two in the present example) of heat generation resistors 142 (specifically, 142a and 142b) are formed on the surface of the curved substrate 141, and an insulating protective layer 143 is laminated on the surface of the curved substrate 141 to cover the heat generation resistors 142.

The heat generation component 140 is supported by a support member 145, and the biasing spring 150 biases the support member 145 so that the heat generation component 140 is pressed against the fixing belt 61.

In the present example, the two heat generation resistors 142 (142a and 142b) extend in the longitudinal direction on the surface of the curved substrate 141 and are arranged at intervals. The two heat generation resistors 142 (142a and 142b) are configured as band-shaped heating wire portions having the same width dimension.

Further, in the present example, as shown in FIG. 15, the pressurization adjustment mechanism 160 is a mechanism in which the base end portion of the biasing spring 150 is attached to a movable plate 161 that is movable up and down, and the eccentric cam 162 is disposed in contact with the lower portion of the movable plate 161. The long diameter position RL and the short diameter position RS are provided in the eccentric cam 162. In addition, the eccentric cam 162 is rotatable by the drive motor 163, and in a case where the movable plate 161 is moved up, the position of the base end portion of the biasing spring 150 is moved up with the movable plate 161, and the heat generation component 140 is pressed against the fixing belt 61.

In the present example, it is intended to change the pressurized state by the pressurization adjustment mechanism 160 and to change the contact region of the second contact region CN2 between the heat generation component 140 and the fixing belt 61 by the pressurization adjustment mechanism 160 between the start-up operation of the fixing device 60 and the printing.

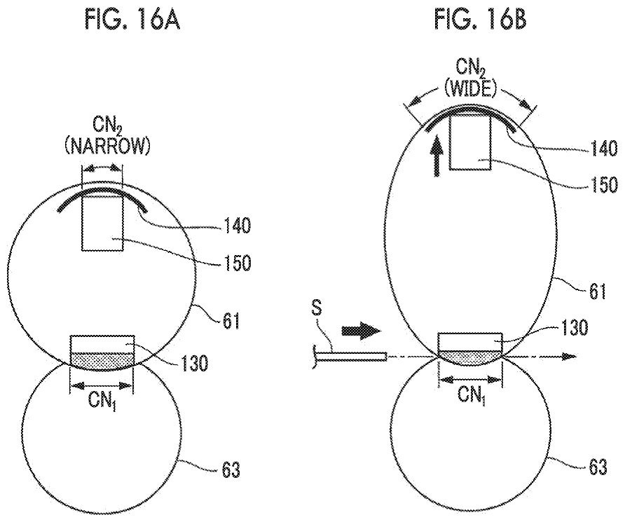

That is, during the start-up of the fixing device 60, the pressurization adjustment mechanism 160 brings the short diameter position RS of the eccentric cam 162 into contact with the movable plate 161 and lowers the position of the movable plate 161. Therefore, as shown in FIG. 16A, the biasing force of the biasing spring 150 on the heat generation component 140 is decreased, and the contact region between the heat generation component 140 and the fixing belt 61 in the second contact region CN2 is narrowed.

Therefore, during the start-up, in order to raise the temperature of the fixing belt 61 to a predetermined temperature with high speed, the contact region is narrowed to prevent heat from being taken from the fixing belt 61, and heat is stored in the fixing belt 61 by the heat generation of the heat generation resistor 142, so that the temperature of the fixing belt 61 can be increased in a short time.

On the other hand, during normal printing, the pressurization adjustment mechanism 160 brings the long diameter position RL of the eccentric cam 162 into contact with the movable plate 161 and raises the position of the movable plate 161. Therefore, as shown in FIG. 16B, the biasing force of the biasing spring 150 on the heat generation component 140 is increased, and the contact region between the heat generation component 140 and the fixing belt 61 in the second contact region CN2 is widened.

In this way, in a case of normal printing, the contact region of the second contact region CN2 is widened. Therefore, in addition to the heat generated by the heat generation resistor 142, the heat stored in the heat generation component 140 is also supplied to the fixing belt 61. Therefore, the heat of the fixing belt 61 is taken away in a case where the medium S passes through the first contact region CN1, but the temperature of the fixing belt 61 immediately rises due to the heat supplied from the heat generation component 140.

In the present example, although the pressurization adjustment mechanism 160 presses the heat generation component 140 upward, the present invention is not limited to this. For example, the design may be appropriately changed to press the heat generation component 140 against the fixing belt 61 in a horizontal direction.

In the present exemplary embodiment, although the example is shown in which the plurality of heat generation resistors 142 (142a and 142b) are configured as the band-shaped heating wire portions having the same width, the present invention is not limited to this. As in Exemplary Embodiment 1 and Exemplary Embodiment 2, the high heat generation portions and the low heat generation portions having different line widths are provided for the heat generation resistor 142, and thus the heat generation state from the heat generation resistor 142 with respect to the fixing belt 61 may also be controlled by the change in the contact region of the second contact region CN2.

### Supplementary Note

(((1)))

A heating device comprising:
a belt-shaped heated unit that rotates in a circulating manner;
a heat generation unit that is provided in contact with a back surface side of the heated unit, and extends in an intersection direction intersecting with a rotation direction of the heated unit to heat the heated unit;
a pressurization unit that brings the heated unit and the heat generation unit into contact with each other in a pressurized state to form a contact region being in contact with the heated unit and extending in a longitudinal direction of the heat generation unit; and
a pressurization adjustment unit that adjusts the pressurized state by the pressurization unit so that a width in a lateral direction of the contact region changes,
wherein the heat generation unit includes a plurality of heat generation resistors extending in the longitudinal direction, a high heat generation portion being narrow and having a high heat generation amount and a low heat generation portion being wide and having a low heat generation amount are formed in a row in the plurality of heat generation resistors, and for at least two heat generation resistors among the plurality of heat generation resistors, the high heat generation portions are formed in different regions in the longitudinal direction of the contact region, and
in a case where a minimum contact region having a minimum width in the lateral direction of the contact region is formed by the pressurization unit, for the at least two heat generation resistors, an entire high heat generation portion is included in a range of the minimum contact region, a part of the low heat generation portion is included in the range of the minimum contact region, and a remaining part of the low heat generation portion is outside the range of the minimum contact region.
   (((2)))

The heating device according to (((1)),
wherein the heat generation unit includes a first heat generation resistor and a second heat generation resistor that extend in the longitudinal direction, a high heat generation portion being narrow and having a high heat generation amount and a low heat generation portion being wide and having a low heat generation amount are formed in a row in the first heat generation resistor, and the high heat generation portion and the low heat generation portion are formed in a row in the second heat generation resistor in a region different from the first heat generation resistor, and
in a case where the minimum contact region having the minimum width in the lateral direction of the contact region is formed by the pressurization unit, an entire high heat generation portion of the first heat generation resistor and the second heat generation resistor is included in the range of the minimum contact region, a part of the low heat generation portion is included in the range of the minimum contact region, and a remaining part of the low heat generation portion is outside the range of the minimum contact region.
   (((3)))

The heating device according to (((1))) or (((2))),
wherein the pressurization unit includes a pressurization member that is rotatably provided to face the heat generation unit with the heated unit interposed therebetween.
   (((4)))

The heating device according to (((1)) or (((2))),
wherein the pressurization unit includes a pressing member that presses the heat generation unit against the heated unit.
   (((5)))

The heating device according to any one of (((1))) to (((4))),
wherein the heated unit comes into contact with the contact region or a heating target medium moving on a downstream side in a rotation direction of the contact region, to heat the heating target medium, and
the heat generation unit includes the plurality of heat generation resistors disposed to include a maximum width region in an intersection direction intersecting with a movement direction of the heating target medium.
   (((6))

The heating device according to (((5))),
wherein the heat generation unit includes the plurality of heat generation resistors that heat the heating target medium moving about a center reference line passing through a center in the intersection direction intersecting with the rotation direction of the heated unit.
   (((7)))

The heating device according to (((2))),
wherein the heated unit heats a heating target medium moving about a center reference line passing through a center in the intersection direction intersecting with the rotation direction of the heated unit, and
the first heat generation resistor that is one of the plurality of heat generation resistors forms the high heat generation portion in a region including a center in the longitudinal direction of the contact region, and forms the low heat generation portion to be close to an end portion in the longitudinal direction with the high heat generation portion interposed therebetween.
   (((8)))

The heating device according to (((7))),
wherein the second heat generation resistor forms the low heat generation portion in a region corresponding to the high heat generation portion of the first heat generation resistor, and forms the high heat generation portion in a region corresponding to the low heat generation portion of the first heat generation resistor.
   (((9)

The heating device according to (((1)))
wherein the heated unit heats a heating target medium moving about a center reference line passing through a center in the intersection direction intersecting with the rotation direction of the heated unit,
the heat generation unit includes a first heat generation resistor to a third heat generation resistor,
the first heat generation resistor forms the high heat generation portion in a region including a center in the longitudinal direction of the contact region, and forms the low heat generation portion to be close to an end portion in the longitudinal direction with the high heat generation portion interposed therebetween,
the second heat generation resistor forms the low heat generation portion in a region corresponding to the high heat generation portion of the first heat generation resistor, and forms the high heat generation portion in a region corresponding to the low heat generation portion of the first heat generation resistor, and
the third heat generation resistor forms the high heat generation portion in a region including the center in the longitudinal direction of the contact region and being narrower than the high heat generation portion of the first heat generation resistor, and forms the low heat generation portion to be close to an end portion in the longitudinal direction with the high heat generation portion interposed therebetween.
   (((10)

The heating device according to any one of (((1))) to (9)
wherein the high heat generation portion and the low heat generation portion are formed in a row via a coupling heat generation portion in which a width dimension gradually changes.
   (((11)))

The heating device according to any one of (((1))) to (((10))),
wherein the coupling heat generation portion is formed in a mountain-shape in which a width dimension linearly changes.
   (((12)))

The heating device according to any one of (((1))) to (((11))),
wherein the heat generation unit includes an elongated substrate, and the plurality of heat generation resistors formed along a longitudinal direction of the substrate.
   (((13)))

The heating device according to (((12))),
wherein the heat generation unit forms the plurality of heat generation resistors along the longitudinal direction on a surface of the substrate on a heated unit side, and the plurality of heat generation resistors are covered with a heat-resistant protective layer.
   ((14)))

The heating device according to any one of ((1)) to 13)),
wherein the heated unit comes into contact with the contact region or a heating target medium moving on a downstream side in a rotation direction of the contact region, to heat the heating target medium,
in a case where the heated unit is heated without causing the heating target medium to pass, the pressurization unit forms the minimum contact region, and
the heat generation unit causes the at least two heat generation resistors including the high heat generation portion in the range of the minimum contact region among the plurality of heat generation resistors to generate heat.
   (((15)))

The heating device according to (((14))),
wherein, in a case where the heated unit is heated by causing the heating target medium to pass,
the pressurization unit forms a contact region wider than the minimum contact region, and
the heat generation unit causes the plurality of heat generation resistors to generate heat in combination depending on a width dimension in an intersection direction intersecting with a movement direction of the heating target medium.
   (((16)))

A heat treatment system comprising:
a treatment unit that performs a predetermined treatment on a heating target medium; and
the heating device according to any one of (((1))) to (((15))) that heats the heating target medium subjected to the treatment by the treatment unit.
   (((17)))

The heat treatment system according to (((16))),
wherein the treatment unit is an image formation unit that forms an unfixed image on the heating target medium, and
the heating device is a fixing device that fixes the unfixed image formed on the heating target medium.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A heating device comprising:
a belt-shaped heated unit that rotates in a circulating manner;
a heat generation unit that is provided in contact with a back surface side of the heated unit, and extends in an intersection direction intersecting with a rotation direction of the heated unit to heat the heated unit;
a pressurization unit that brings the heated unit and the heat generation unit into contact with each other in a pressurized state to form a contact region being in contact with the heated unit and extending in a longitudinal direction of the heat generation unit; and
a pressurization adjustment unit that adjusts the pressurized state by the pressurization unit so that a width in a lateral direction of the contact region changes,
wherein the heat generation unit includes a plurality of heat generation resistors extending in the longitudinal direction, a high heat generation portion being narrow and having a high heat generation amount and a low heat generation portion being wide and having a low heat generation amount are formed in a row in the plurality of heat generation resistors, and for at least two heat generation resistors among the plurality of heat generation resistors, the high heat generation portions are formed in different regions in the longitudinal direction of the contact region, and
in a case where a minimum contact region having a minimum width in the lateral direction of the contact region is formed by the pressurization unit, for the at least two heat generation resistors, an entire high heat generation portion is included in a range of the minimum contact region, a part of the low heat generation portion is included in the range of the minimum contact region, and a remaining part of the low heat generation portion is outside the range of the minimum contact region.

2. The heating device according to claim 1,
wherein the heat generation unit includes a first heat generation resistor and a second heat generation resistor that extend in the longitudinal direction, a high heat generation portion being narrow and having a high heat generation amount and a low heat generation portion being wide and having a low heat generation amount are formed in a row in the first heat generation resistor, and the high heat generation portion and the low heat generation portion are formed in a row in the second heat generation resistor in a region different from the first heat generation resistor, and
in a case where the minimum contact region having the minimum width in the lateral direction of the contact region is formed by the pressurization unit, an entire high heat generation portion of the first heat generation resistor and the second heat generation resistor is included in the range of the minimum contact region, a part of the low heat generation portion is included in the range of the minimum contact region, and a remaining part of the low heat generation portion is outside the range of the minimum contact region.

3. The heating device according to claim 1,
wherein the pressurization unit includes a pressurization member that is rotatably provided to face the heat generation unit with the heated unit interposed therebetween.

4. The heating device according to claim 1,
wherein the pressurization unit includes a pressing member that presses the heat generation unit against the heated unit.

5. The heating device according to claim 1,
wherein the heated unit comes into contact with the contact region or a heating target medium moving on a downstream side in a rotation direction of the contact region, to heat the heating target medium, and
the heat generation unit includes the plurality of heat generation resistors disposed to include a maximum width region in an intersection direction intersecting with a movement direction of the heating target medium.

6. The heating device according to claim 5,
wherein the heat generation unit includes the plurality of heat generation resistors that heat the heating target medium moving about a center reference line passing through a center in the intersection direction intersecting with the rotation direction of the heated unit.

7. The heating device according to claim 2,
wherein the heated unit heats a heating target medium moving about a center reference line passing through a center in the intersection direction intersecting with the rotation direction of the heated unit, and
the first heat generation resistor that is one of the plurality of heat generation resistors forms the high heat generation portion in a region including a center in the longitudinal direction of the contact region, and forms the low heat generation portion to be close to an end portion in the longitudinal direction with the high heat generation portion interposed therebetween.

8. The heating device according to claim 7,
wherein the second heat generation resistor forms the low heat generation portion in a region corresponding to the high heat generation portion of the first heat generation resistor, and forms the high heat generation portion in a region corresponding to the low heat generation portion of the first heat generation resistor.

9. The heating device according to claim 1,
wherein the heated unit heats a heating target medium moving about a center reference line passing through a center in the intersection direction intersecting with the rotation direction of the heated unit,
the heat generation unit includes a first heat generation resistor to a third heat generation resistor,
the first heat generation resistor forms the high heat generation portion in a region including a center in the longitudinal direction of the contact region, and forms the low heat generation portion to be close to an end portion in the longitudinal direction with the high heat generation portion interposed therebetween,
the second heat generation resistor forms the low heat generation portion in a region corresponding to the high heat generation portion of the first heat generation resistor, and forms the high heat generation portion in a region corresponding to the low heat generation portion of the first heat generation resistor, and
the third heat generation resistor forms the high heat generation portion in a region including the center in the longitudinal direction of the contact region and being narrower than the high heat generation portion of the first heat generation resistor, and forms the low heat generation portion to be close to an end portion in the longitudinal direction with the high heat generation portion interposed therebetween.

10. The heating device according to claim 1,
wherein the high heat generation portion and the low heat generation portion are formed in a row via a coupling heat generation portion in which a width dimension gradually changes.

11. The heating device according to claim 10,
wherein the coupling heat generation portion is formed in a mountain-shape in which a width dimension linearly changes.

12. The heating device according to claim 1,
wherein the heat generation unit includes an elongated substrate, and the plurality of heat generation resistors formed along a longitudinal direction of the substrate.

13. The heating device according to claim 12,
wherein the heat generation unit forms the plurality of heat generation resistors along the longitudinal direction on a surface of the substrate on a heated unit side, and the plurality of heat generation resistors are covered with a heat-resistant protective layer.

14. The heating device according to claim 1,
wherein the heated unit comes into contact with the contact region or a heating target medium moving on a downstream side in a rotation direction of the contact region, to heat the heating target medium,
in a case where the heated unit is heated without causing the heating target medium to pass, the pressurization unit forms the minimum contact region, and
the heat generation unit causes the at least two heat generation resistors including the high heat generation portion in the range of the minimum contact region among the plurality of heat generation resistors to generate heat.

15. The heating device according to claim 14,
wherein, in a case where the heated unit is heated by causing the heating target medium to pass,
the pressurization unit forms a contact region wider than the minimum contact region, and
the heat generation unit causes the plurality of heat generation resistors to generate heat in combination depending on a width dimension in an intersection direction intersecting with a movement direction of the heating target medium.

16. A heat treatment system comprising:
a treatment unit that performs a predetermined treatment on a heating target medium; and
the heating device according to claim 1 that heats the heating target medium subjected to the treatment by the treatment unit.

17. A heat treatment system comprising:
a treatment unit that performs a predetermined treatment on a heating target medium; and
the heating device according to claim 2 that heats the heating target medium subjected to the treatment by the treatment unit.

18. A heat treatment system comprising:
a treatment unit that performs a predetermined treatment on a heating target medium; and
the heating device according to claim 3 that heats the heating target medium subjected to the treatment by the treatment unit.

19. A heat treatment system comprising:
a treatment unit that performs a predetermined treatment on a heating target medium; and
the heating device according to claim 4 that heats the heating target medium subjected to the treatment by the treatment unit.

20. The heat treatment system according to claim 16,
wherein the treatment unit is an image formation unit that forms an unfixed image on the heating target medium, and
the heating device is a fixing device that fixes the unfixed image formed on the heating target medium.
